(19) United States
(12) Patent Application Publication
(10) Pub. No.: US 2013/0212338 A1
(43) Pub. Date: Aug. 15, 2013

(54) MULTICORE PROCESSOR

(71) Applicants: Moe Konta, Tokyo (JP); Takahiro Ohizumi, Tokyo (JP); Shingo Yamazaki, Tokyo (JP)

(72) Inventors: Moe Konta, Tokyo (JP); Takahiro Ohizumi, Tokyo (JP); Shingo Yamazaki, Tokyo (JP)

(21) Appl. No.: 13/767,333

(22) Filed: Feb. 14, 2013

(30) Foreign Application Priority Data
Feb. 14, 2012 (JP) 2012-029674
Feb. 8, 2013 (JP) 2013-023797

(51) Int. Cl. G06F 3/06

(52) U.S. Cl. CPC G06F 3/067
USPC 711/147

(57) ABSTRACT

A multicore processor includes a plurality of cores; a shared memory that is shared by the cores and that is divided into a plurality of storage areas whose writable data sizes are determined in advance; a receiving unit that receives a task given to the cores; and a writing unit that writes the received task in one of the storage areas that is set in advance according to a data size of the task.

### CROSS-REFERENCE TO RELATED APPLICATIONS

The present application claims priority to and incorporates by reference the entire contents of Japanese Patent Application No. 2012-029674 filed in Japan on Feb. 14, 2012 and Japanese Patent Application No. 2013-023797 filed in Japan on Feb. 8, 2013.

### BACKGROUND OF THE INVENTION

1. Field of the Invention

The present invention relates to a multicore processor including a plurality of cores.

2. Description of the Related Art

Conventionally, a tightly-coupled multicore processor system is known in which a plurality of cores share a main memory. As an example of such a multicore processor system, as described in Japanese Patent Application Laid-open No. 57-161962, a configuration has been employed in which a main memory is provided with message exchange buffers for respective cores, and data is exchanged via the exchange buffers.

Specifically, a core on the transmitting side sets data in a message exchange buffer in the shared memory, and thereafter sends an interrupt request to a core on the receiving side. The core on the receiving side acquires the data from the message exchange buffer and sets the data in a receiving buffer. After completion of a requested process with the received data, the core on the receiving side sets a message indicating completion of the process in the message exchange buffer. The core on the receiving side sends an interrupt request to the core on the transmitting side, and the core on the transmitting side receives the message indicating the completion of the process from the message exchange buffer.

However, in the inter-core communication of a system as described above, when the inter-core communication is performed for a certain task, write to a memory for other tasks is excluded. Therefore, a wait occurs in a process, which may result in the reduced processing speed.

Therefore, there is a need to improve the processing speed of a multicore processor that processes a plurality of tasks.

### SUMMARY OF THE INVENTION

According to an embodiment, there is provided a multicore processor that includes a plurality of cores; a shared memory that is shared by the cores and that is divided into a plurality of storage areas whose writable data sizes are determined in advance; a receiving unit that receives a task given to the cores; and a writing unit that writes the received task in one of the storage areas that is set in advance according to a data size of the task.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating an overall configuration of a multicore processor;

FIG. 2 is a diagram illustrating an overview of a process concerning write to a main memory by the multicore processor;

FIG. 3 is a sequence diagram illustrating the flow of a process when write to the main memory is possible between cores; and

FIG. 4 is a sequence diagram illustrating the flow of a process when write to the main memory is impossible between the cores.

### DETAILED DESCRIPTION OF THE PREFERRED EMBODIMENTS

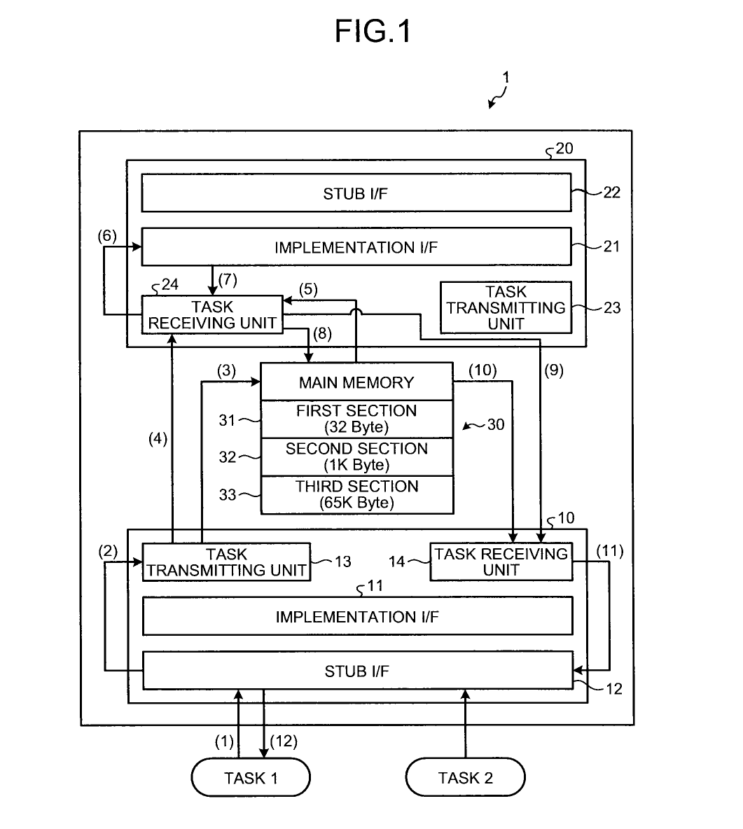

Exemplary embodiments of the present invention will be explained in detail below with reference to the accompanying drawings. FIG. 1 is a block diagram illustrating a configuration of a multicore processor according to an embodiment. A multicore includes a plurality of processor cores in a single processor package. In the embodiment, an example is illustrated in which the multicore processor includes two cores. However, the present invention is applicable to a multicore processor including three or more cores.

A multicore processor 1 illustrated in FIG. 1 includes a first core 10, a second core 20, and a main memory 30. The first core 10 includes an implementation I/F 11, a stub I/F 12, a task transmitting unit 13, and a task receiving unit 14. Similarly, the second core 20 includes an implementation I/F 21, a stub I/F 22, a task transmitting unit 23, and a task receiving unit 24. A task is a processing instruction to be executed upon request by various computer programs or libraries.

The implementation I/Fs 11 and 21 are interfaces that accept a received task as a processing instruction to be executed by a processor. The stub I/Fs 12 and 22 function as logically-set stubs that can virtually call a system of another core because the stubs I/F 12 and 22 are unable to directly call the implementation I/Fs 21 and 11 of different cores. The stub I/F 12 of the first core 10 is set as an interface that is logically the same as the implementation I/F 21 of the second core 20. On the other hand, the stub I/F 22 of the second core 20 is set as an interface that is logically the same as the implementation I/F 11 of the first core 10.

The task transmitting units 13 and 23 serve as writing units that write a task received by a core into the main memory 30. Upon writing the task, the task transmitting unit 13 sends a write notice to the task receiving unit 24 of the second core 20, and the task transmitting unit 23 sends a write notice to the task receiving unit 14 of the first core 10. During the write to the main memory 30, the task transmitting units 13 and 23 perform exclusive control to prohibit writing data due to other processes to a storage area of the main memory 30. The task receiving units 14 and 24 serve as receiving units that perform a process for reading data from a specified location in the main memory 30 upon reception of the write notice from the task transmitting units 13 and 23. In this way, data is exchanged between the first core 10 and the second core 20 via the main memory 30.

The main memory 30 (shared memory) includes three sections (storage areas). A first section 31 is a section used to write and read data whose size is 32 bytes or smaller. A second section 32 is a section used to write and read data whose size is greater than 32 bytes and equal to or smaller than 1 kilobytes. A third section 33 is a section used to write and read data whose size is greater than 1 kilobytes and equal to or smaller than 65 kilobytes. In the embodiment, a case is illustrated in which all of the sections have different sizes. However, it may be possible to provide a plurality of sections provided corresponding to the same size. The main memory 30 further has an area for storing address information indicating a position range of each of the sections and flag information indicating whether or not each of the sections 31 to 33 is in use, within an area (not illustrated) other than the areas of the sections 31 to 33.

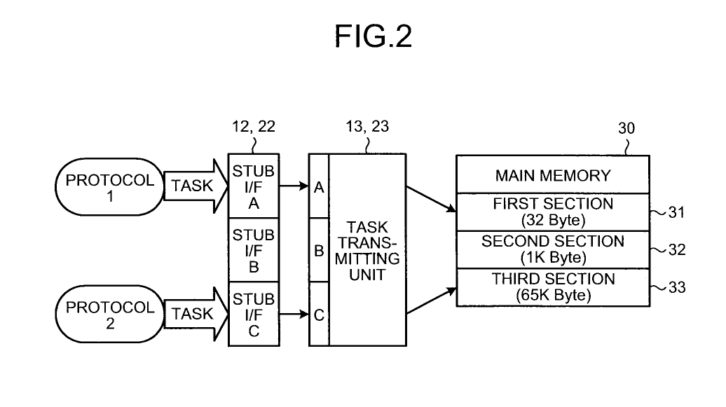

FIG. 2 is a diagram illustrating an overview of which of the sections 31 to 33 is used to write a task. As illustrated in FIG. 2, each of the stub I/Fs 12 and 22 includes interfaces each corresponding to a protocol (a computer program or a library). For example, a stub I/F A is called by a task requested by a protocol 1, and the task is given to the task transmitting unit 13. An interface to be called is set depending on the data size of a task. Therefore, a section used for write is set in advance according to the data size of a task for each of the tasks requested by a protocol.

A flow of the process for exchanging data between cores will be explained below with reference to FIG. 1. In the explanation, it is assumed that data is sent from the first core 10 to the second core 20. As illustrated in FIG. 1, as shown by a line (1), a task, the request of which is given to the first core 10, calls the stub I/F 12 that is provided in the first core 10 and that is logically connected to the second core 20. In this case, the stub I/F 12 to be called is determined based on a memory size needed for writing the task. Then, as shown by a line (2), the stub I/F 12 sends the requested task to the task transmitting unit 13 to request a processing. As shown by a line (3), the task transmitting unit 13 that has received the request writes the task in the main memory 30. In this case, the task is written to the section 31, 32, or 33 that is set in advance depending on the data size of the task. In the embodiment, a section of the main memory 30 to be used for writing a task is determined in advance in association with an interface provided in the stub I/F 12 to be called. Therefore, the section to be used for writing a task is determined at the point when the task selects an interface from interfaces of the stub I/F 12. The section to be used for writing a task is determined based on a corresponding data size set for each of the sections 31 to 33 as described above. The task transmitting unit 13 performs exclusive control to prohibit writing other tasks to the section 31, 32, or 33 to which task data is being written, until the task receiving unit 14 reads the task data as will be described later. When such a time comes, the task transmitting unit 13 is released and allowed to accept and process other tasks.

Then, as shown by a line (4), the task transmitting unit 13 specifies the section 31, 32, or 33 of the main memory 30 to which the data has been written, and sends a notice of the specified section to the task receiving unit 24 of the second core 20. As shown by a line (5), the task receiving unit 24 that has received the notice reads the written task data, from the specified section 31, 32, or 33 of the main memory 30. As shown by a line (6), the task receiving unit 24 calls the implementation I/F 21, and sends the read task data to the implementation I/F 21. As shown by a line (7), the implementation I/F 21 that has received the task data executes processing based on the task data, and sends an execution result as a reply to the task receiving unit 24. As shown by a line (8), the task receiving unit 24 writes the received execution result in the corresponding section 31, 32, or 33 of the main memory 30. As shown by a line (9), the task receiving unit 24 notifies the task receiving unit 14 of the first core 10 that the execution result is written. As shown by a line (10), the task receiving unit 14 of the first core 10 reads the execution result of the task performed by the second core 20 from the specified section 31, 32, or 33 of the main memory 30. At this time, the exclusive control on the main memory 30 due to the task 1 is terminated. Specifically, the flag information indicating whether or not the corresponding section is in use is updated. As shown by a line (11), the task receiving unit 14 sends the read execution result of the task to the stub I/F 12 that has been called. Finally, as shown by a line (12), the stub I/F 12 sends the execution result as a reply to the task 1 and completes the task processing. Meanwhile, when a task is given to the second core 20, the same process as above is performed.

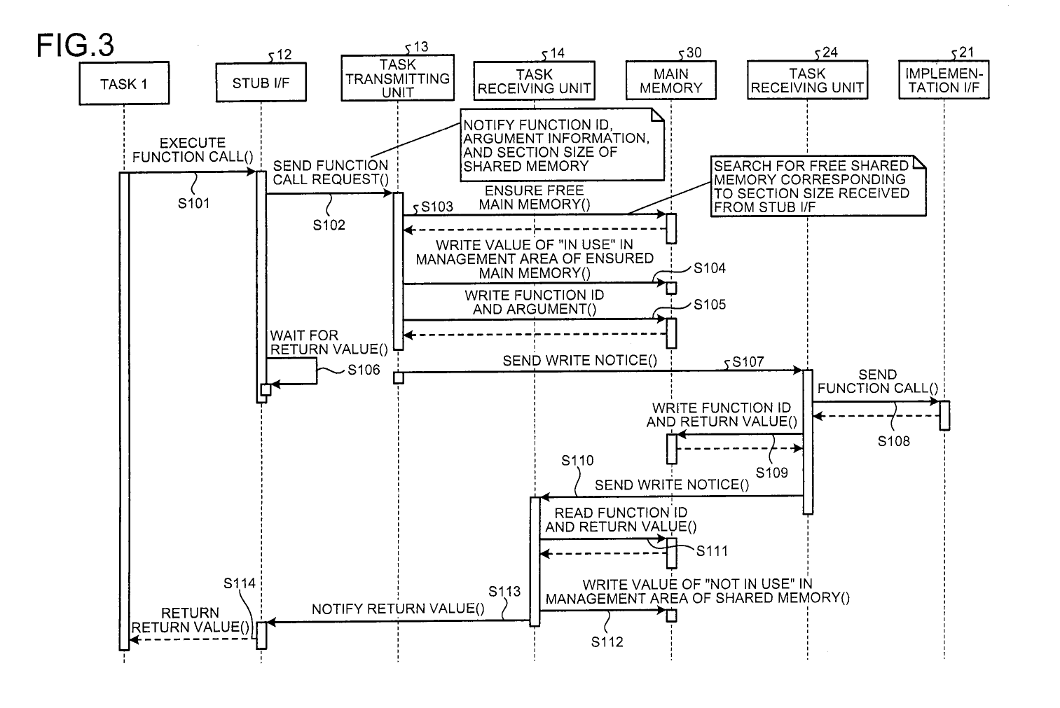

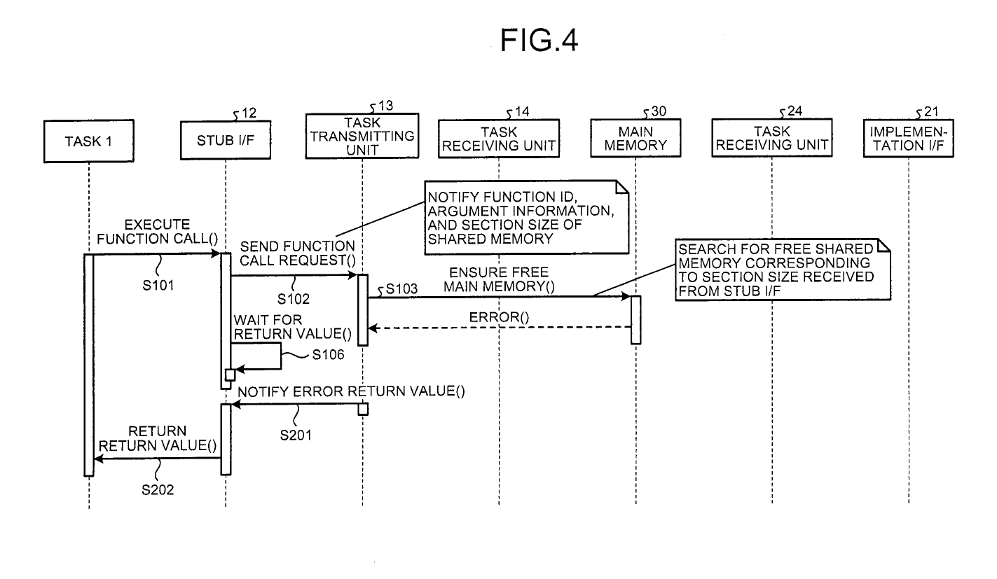

The flow of the task processing as described above will be explained below with reference to sequence diagrams in FIG. 3 and FIG. 4. FIG. 3 illustrates a case that write to the main memory 30 has been successful. FIG. 4 illustrates a case that write to the main memory 30 has failed. As illustrated in FIG. 3, the task 1 executes a function call on the stub I/F 12 (Step S101). Subsequently, the stub I/F 12 sends a function call request containing a function ID, argument information, information on a section size needed for writing a task to the main memory 30, or the like to the task transmitting unit 13 (Step S102). The task transmitting unit 13 ensures the section 31, 32, or 33 of the main memory 30 corresponding to the section size requested by the stub I/F 12 (Step S103). The task transmitting unit 13 updates the flag information indicating whether or not the ensured section 31, 32, or 33 of the main memory 30 is in use with a value indicating “in use” (Step S104).

Subsequently, the task transmitting unit 13 writes the function ID and an argument to the corresponding section 31, 32, or 33 of the main memory 30 (Step S105). After the above-descibed processes, the stub I/F 12 enters a wait state until receiving a reply from the second core 20 (Step S106). Subsequently, the task transmitting unit 13 notifies the task receiving unit 24 of the second core 20 about a write location in the section 31, 32, or 33 of the main memory 30 (Step S107). The task receiving unit 24 sends a function call to the implementation I/F 21, causes the processing to be executed via the implementation I/F 21, and receives a processing result (Step S108).

The task receiving unit 24 writes a function ID and a return value, which are obtained as the processing result of the task, in the main memory 30 (Step S109). In this case, the section 31, 32, or 33 used to the write is the same as the section ensured at Step 5103. Subsequently, the task receiving unit 24 notifies the task receiving unit 14 of the first core 10 about location information on the main memory 30 in which the return value is written (Step S110). The task receiving unit 14 reads the function ID and the return value from the main memory 30 based on the specified location information (Step S111). At the same time, the task receiving unit 14 updates the flag information on the corresponding section 31, 32, or 33 of the main memory 30 with “not in use” (Step S112). The task receiving unit 14 notifies the stub I/F 12 about the return value (Step S113), and the return value is returned to the task 1 (Step S114).

With reference to FIG. 4, a case will be explained below that write to the main memory 30 has failed. The processes to Step S103 are the same as those in FIG. 3; therefore, explanation thereof will be omitted. As illustrated in FIG. 4, the task transmitting unit 13 receives an error as a result of the process for ensuring a memory area at Step S103. The task transmitting unit 13 notifies the stub I/F 12 about an error return value (Step S201), and the error return value is returned to the task 1 (Step S202).

In the multicore processor 1 of the embodiment as described above, when data is exchanged between a plurality of cores via the main memory 30, the sections 31 to 33 of the main memory 30 to be used are changed depending on the data size of a task. Therefore, when a plurality of tasks are to be processed in parallel, it is possible to reduce the frequency that a wait time occurs due to prohibition of write to the main memory 30 by exclusive control. Therefore, it is possible to improve the processing speed of a multicore processor system that processes a plurality of tasks.

As an example of the tasks to be processed in parallel, there may be a case that a process for acquiring a management screen of a printer or the like by an HTTP protocol and a process for controlling the state of the printer by an SNMP protocol. Even when there are tasks that are frequently requested at the same time, it is possible to prevent a wait time to access a memory, enabling to improve the processing speed.

Furthermore, the task transmitting unit 13 can receive and process a new task when the write to the main memory 30 is completed. Therefore, it is possible to improve the processing speed.

In the embodiment, the main memory 30 has three sections. However, the number of the sections can be changed appropriately. Furthermore, it is possible to provide a plurality of sections corresponding to the same data size. The data size that can be stored in each of the sections of the main memory 30 is not limited to the example illustrated in the embodiment. A combination of the data sizes may be changed to an arbitrary combination.

According to an embodiment of the present invention, it is possible to improve the processing speed of a multicore processor that processes a plurality of tasks.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A multicore processor comprising:
a plurality of cores;
a shared memory that is shared by the cores and that is divided into a plurality of storage areas whose writable data sizes are determined in advance;
a receiving unit that receives a task given to the cores; and
a writing unit that writes the received task in one of the storage areas that is set in advance according to a data size of the task.

2. The multicore processor according to claim 1, wherein the shared memory has at least two storage areas provided corresponding to the same data size.

3. The multicore processor according to claim 1, wherein
when writing the task in the storage area, the writing unit performs an exclusive process to prevent writing other tasks and notifies the other core about a write position of the task in the shared memory, and
when the other core reads, from the storage area, a return value as a result of completion of processing on the task, the writing unit terminates the exclusive process.
